(19) United States
(12) Patent Application Publication
(10) Pub. No.: US 2006/0114344 A1
(43) Pub. Date: Jun. 1, 2006

(54) Image pick up module with optical element

(75) Inventors: Chon Su Kyong, Seoul (KR); Ho Seop Jeong, Kyeonggi-do (KR); Dong Ik Shin, Kyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/158,469

(22) Filed: Jun. 21, 2005

(30) Foreign Application Priority Data
Nov. 30, 2004 (KR) 10-2004-0099149

(51) Int. Cl. H04N 5/335

(52) U.S. Cl. 348/296

(57) ABSTRACT

An image pickup module including an optical element capable of functioning as an aperture and/or a shutter. The optical element includes a pair of transparent electrode substrates with a liquid crystal-photopolymer interposed therebetween. The image pickup module further includes a lens for making images and a sensor for converting the light passing through the lens into electrical signals. The optical element can be electrically operated to function as an aperture and/or a shutter without additional mechanical operating means. Being electrically operated, the optical element can reduce the size of the image pickup module in addition to protecting the image pickup module from mechanical noises and impacts which arise from the use of mechanical driving means.

### INCORPORATION BY REFERENCE

The present application claims priority under 35 U.S.C. §119 to Korean Patent Application No. 2004-99149 filed on Nov. 30, 2004. The content of the application is incorporated herein by reference in its entirety.

### BACKGROUND OF THE INVENTION

1. Field of the Invention

The present invention is in the field of an image pickup module. More particularly, the present invention relates to an image pickup module comprising an optical element capable of performing the functions of an aperture and a shutter.

2. Description of the Related Art

Finding applications in a variety of optical fields including camera modules for cellular phone handsets, digital still cameras, camcorders, etc. an image pickup system comprises a lens for making images, a sensor for converting images to electrical signals, various chips, such as image signal processor (ISP) and digital signal processor (DSP) chips, for processing signals, and an aperture and a shutter for controlling the quantity of light and exposure time.

An aperture and a shutter are regarded as unimportant in a low resolution sensor module, but play a very important role in obtaining clear images in a high resolution sensor module.

Conventionally, mechanically controllable parts are used for apertures and shutters with mechanical driving means applied thereto. Thus, apertures and shutters contributes to the thicknesses of camera systems.

With reference to FIG. 1, the two conventional types of camera shutters are shown: a leaf shutter (1a), also called between-the-lens-shutter, and a focal plane shutter (1b). As shown in FIG. 1a, the leaf shutter 10 has, for example, five blades 12 which simultaneously advance forward or draw back from the center to drive the leaf shutter 10. To close or open the leaf shutter, mechanical driving means (not shown) is required to be linearly combined with each blade.

The focal plane shutter 20, as shown in FIG. 1b, has a curtain 22 made of metal or cloth which is folded to expose the film or the charge-coupled device (CCD) or unfolded to end the exposure. The focal plane shutter is mounted in front of the CCD or the film or behind the lens. Instead of the horizontal focal plane shutter shown in FIG. 1b, a vertical focal plane shutter may be used which is operated by vertically folding or unfolding the curtain. Like the leaf shutter, the focal plane shutter requires linear mechanical driving means (not shown) which functions to fold and unfold the curtain made of metal or cloth.

FIG. 2 depicts various states of an aperture 30 depending on f-numbers. As shown in FIG. 2, the aperture 30 regulates the quantity of light passing through it into the camera by means of a concentrically arranged curtain 32 within a predetermined range (e.g., f-number). Conventionally, the aperture is also mechanically operated.

As described, the mechanical operation of the aperture and the shutter requires mechanical driving means therefor, thus increasing the thickness or volume of the camera system by an amount of the driving means in addition to the aperture and shutter themselves. Besides, the mechanical operation for folding or unfolding the curtain or for moving the blades apart or overlapping the blades with each other makes noise and causes impacts.

### SUMMARY OF THE INVENTION

Accordingly, the present invention has been made keeping in mind the above problems occurring in the prior art, and an object of the present invention is to provide an optical element which can perform the functions of an aperture and a shutter without mechanical operating means.

Another object of the present invention is to provide an image pickup module comprising an optical element which is electrically operated by the use of a liquid crystal-photopolymer.

To accomplish the above objects, there is provided an image pickup module, comprising a lens for making images, a sensor for converting the light passing through the lens into electrical signals, and an optical elements for controlling the quantity of light and exposure time, wherein the optical element comprises: a liquid crystal-photopolymer layer capable of passing light therethrough according to the application of an electric field thereto; and a pair of transparent electrode substrates, positioned to sandwich the liquid crystal-photopolymer layer, comprising on its each side an electrode pattern for applying an electric field across the liquid crystal-photopolymer layer, the electrode pattern on one of the transparent electrode substrates having concentric circles in which a circle has a half area relative to the next outer circle.

In accordance with the present invention, the liquid crystal-photopolymer layer is made of polymer-dispersed liquid crystal.

In accordance with the present invention, the the liquid crystal-photopolymer layer is equally divided into a plurality of sub liquid crystal photopolymer layers by a plurality of sub transparent electrode substrates which are formed in parallel with the pair of the transparent electrode substrates at equal distances within the liquid crystal-photopolymer layer.

The formation of the plurality of sub liquid crystal photopolymer layers brings about a reduction in the quantity of the power required for applying an electric field to the liquid crystal-photopolymer layer. As the power required for the application of an electric field to one of the sub liquid crystal-photopolymer layers is smaller than that for the intact liquid crystal-photopolymer, the optical element comprising the plurality of sub liquid crystal-photopolymer can be electrically operated with lower power than the optical element comprising the intact liquid crystal-photopolymer.

In accordance with the present invention, the electric field is provided by an alternating current power source. An alternative current is used so as to prevent the electric field from being shielded on the surface of the droplets within the polymer-dispersed liquid crystals (PDLC).

Also, in accordance with the present invention, the electric field is selectively applied to all or relatively inner ones of the concentric circles, so that he optical element can function as an aperture. On the other hand, when the electric field, after being generated, is not supplied to allow the liquid crystal-photopolymer, the transmission of light is shielded, so that the optical element can function as a shutter. Accordingly, the optical element of the present invention can be used as both an aperture and a shutter.

### BRIEF DESCRIPTION OF THE DRAWINGS

The above and other objects, features and advantages of the present invention will be more clearly understood from the following detailed description taken in conjunction with the accompanying drawings, in which:

FIG. 1a illustrates a conventional leaf shutter;

FIG. 1b illustrates a conventional focal plane shutter;

FIG. 2 illustrates a conventional aperture;

FIG. 3 is a schematic view showing a part of an image pickup module comprising an optical element according to the present invention;

FIGS. 4a and 4b are block diagrams showing electro-optical properties of a liquid crystal-photopolymer used in the present invention;

FIG. 5 is a schematic plan view showing the optical element of FIG. 3;

FIGS. 6a to 6c are schematic views showing the use of the optical element of FIG. 5 as an aperture;

FIGS. 7a and 7b are schematic views showing the use of the optical element of FIG. 5 as a shutter;

FIG. 8a is a schematic cross sectional view showing an embodiment of the optical element of FIG. 5;

FIG. 8b is a schematic cross sectional view showing another embodiment of the optical element of FIG. 5; and

FIG. 8c is a schematic cross sectional view showing a sub transparent electrode substrate in detail.

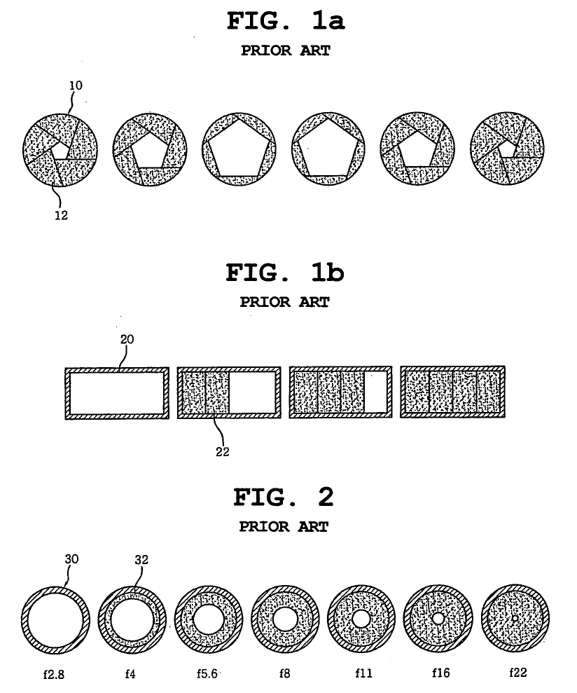

### DETAILED DESCRIPTION OF THE INVENTION

Reference now should be made to the drawings, in which the same reference numerals are used throughout the different drawings to designate the same or similar components.

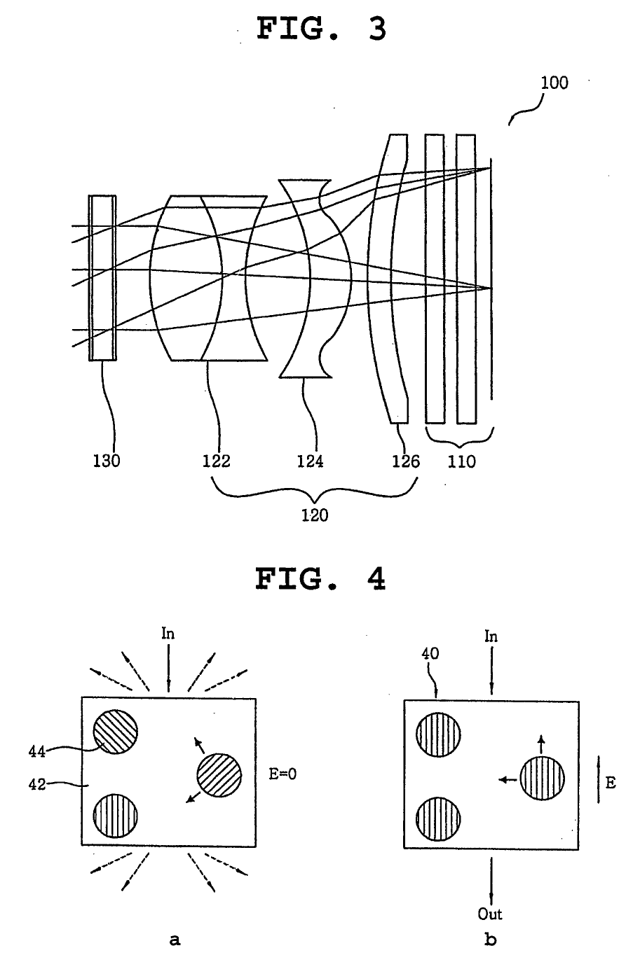

With reference to FIG. 3, a structural diagram is given schematically showing an important part of an image pickup module 100 in which an optical element according to the present invention functions as an aperture and/or a shutter. This image pickup module is not an analog type using films, but corresponds to a digital type using a sensor which detects light and converts it into electrical signals.

The image pickup module 100 comprises a lens 120 which receives light to make images, a sensor 110 which converts the light (image) passing through the lens 120 into electrical signals, and an optical element 130 which regulates the amount of light passing though into the lens 120 or the time of exposure. For convenience's sake, a description will be omitted of other general components for an image pickup system, such as signal processing chips, e.g. ISP, DSP, etc.

As for the lens 120, it may be a combination of lenses comprising a chromatic aberration correcting lens 122, an optical path regulating lens 124, and a distortion correcting lens 126. In FIG. 3, a doublet lens, in which a concave lens is combined with a convex lens, is used to correct chromatic aberrations while a seagull lens is responsible for the correction of distortions. However, this constitution is shown to illustrate the present invention, but is not limitative. It should be noted that various combinations of lenses could be employed in the present invention.

The optical element 130 according to the present invention features the use of a medium which changes in refractive index, particularly, a combined medium, also called liquid crystal-photopolymer. Since the development of DMP-128 by Polaroid Corporation, liquid crystal-photopolymers have been advanced to polymer-dispersed liquid crystals (hereinafter referred to as “PDLCs”) which the present invention will adopt.

Referring to FIGS. 4a and 4b, electro-optical properties of the liquid crystal-photopolymer used in the optical element of the present invention are shown in block diagrams. PDLCs 40 are made by inducing phase separation in a homogeneous mixture of liquid crystal and monomers by polymerizing the matrix by, for example, UV curing. As the monomer polymerizes, the liquid crystal phase separates into droplets 44 separated by the walls of the cured polymer matrix 42.

In the unaddressed state, as shown in FIG. 4a, the nematic texture within the droplets 44 is randomly oriented with respect to neighboring droplets, so that each droplet serves as a light scatter to cause the PDLC 40 to appear white due to light scattering as indicated by dotted line arrows in FIG. 4a. On the other hand, when an electric field E is applied to the PDLC 40, the droplets 44 are allowed to align with the direction of the applied field so as to have the same refractive index as that of the polymer matrix 42. Therefore, the PDLC 40 turns transparent, passing light therethrough as indicated by arrows in FIG. 4b.

The present invention is characterized in that an optical element with such electro-optical properties of PDLCs is used to take charge of the functions of an aperture and/or a shutter in an image pickup module.

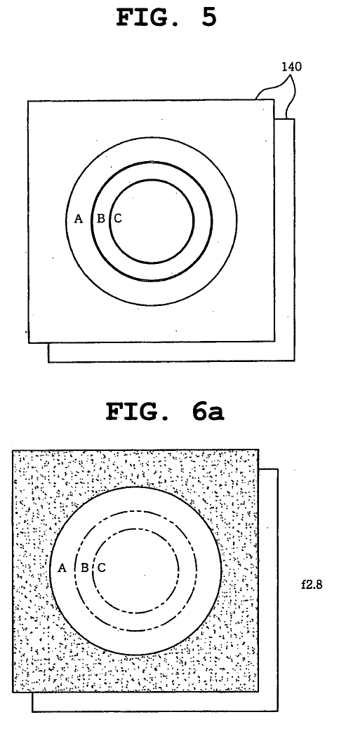

FIG. 5 depicts the optical element functioning as an aperture and/or a shutter, in which predetermined patterns are formed on a transparent electrode substrate, in accordance with an embodiment of the present invention. The patterns are concentrically circular, with a circle having about half the area of the next outer concentric circle. This satisfies the standard of regulating the amount of light (e.g., aperture standard according to f-number).

It should be understood that the three patterns A, B and C depicted in FIG. 5 are illustrative, but not limitative. The number of patterns, that is, the regulation extent of the aperture, is determined according to the number of pixels of the camera module. For convenience's sake, only three patterns are used as examples in description of regulating the amount of light.

In a plan view of the optical element 130, the patterns A, B, C are in the relationship of concentric circles. The innermost pattern C is formed as a closed circle. The area of a concentric circle is twice than that of the next inner concentric circle.

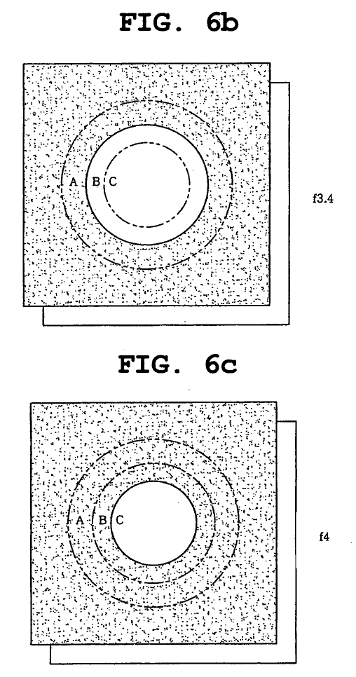

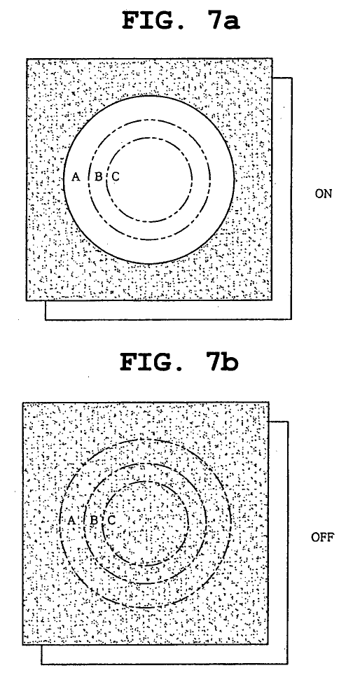

As will be described with reference to FIGS. 6a-6c and 7a-7b, the optical element of the present invention can function as an aperture when an electric field is selectively applied to each of the patterns while serving as a shutter when an electric field is collectively applied to all of the patterns.

FIGS. 6a-6c illustrate the cases that the optical element of the present invention is used as an aperture. When an electric field is applied to all of the patterns A, B and C, as shown in FIG. 6a, all of the PDLCs patterned on the optical element are transparent so that the amount of light passing through is maximized. Corresponding to f2.8, this case allows the PDLC patterns to transmit a maximum amount of light into the camera module. In this regard, the outer border of the pattern A can be utilized as a stop when the optical element is used as an aperture.

FIG. 6b shows the case where an electric field is applied to the patterns B and C, but not to the pattern A. Corresponding to f4, the amount of light passing through the PDLCs is reduced by half in comparison to the case of FIG. 6a.

The application of an electric field only to the innermost pattern C, which is depicted in FIG. 6c, reduces the amount of light passing through the PDLCs by half relative to FIG. 6b. This case can be expressed as f5.6.

As such, the optical element of the present invention takes advantage of the light transmission of the patterns A, B and C in correspondence with the selective application of an electric field, thereby functioning as an aperture.

Next, turning to FIGS. 7a-7b, there is illustrated the case that the optical element of the present invention functions as a shutter. FIG. 7a is an ON state in which a maximum amount of light passes through the PDLCs by applying an electric field to all of the patterns A, B and C. FIG. 7b is an OFF state in which no light passes through the PDLCs in the absence of an electric field.

Generally, when functioning as a shutter, the patterns A, B and C change from the OFF state of FIG. 7b to the ON state of FIG. 7a, are maintained at this state for an extremely short period of time, and then return back to the OFF state of FIG. 7b.

In the case of taking charge of the function of an aperture together, the optical element of the present invention requires a process somewhat different from the general case in order to function as a shutter. For instance, while being operated together with the sensor 110 of FIG. 3 in the image pickup module, the optical element can function as a shutter.

When the sensor is in a non-operation state, the optical element of the present invention functions as an aperture so that the lens makes an image in the presence of an electric field. Extremely shortly after the sensor starts to function, the optical element of the present invention is in an OFF state as shown in FIG. 7b so as to perform the function of the shutter.

It should be noted that the performance of both aperture and shutter functions is impossible in an analog type system that uses film, but possible in a digital type system that uses a sensor. That is, the optical element of the present invention in which an aperture and a shutter are integrated is preferably used in a digital type image pickup module. If functioning only as either an aperture or a shutter, the optical element according to the present invention can be applied to all image pickup modules, whether digital or analog.

The principle of making the optical element of the present invention function as an aperture and/or a shutter is based on the structure of the optical element as will be described below.

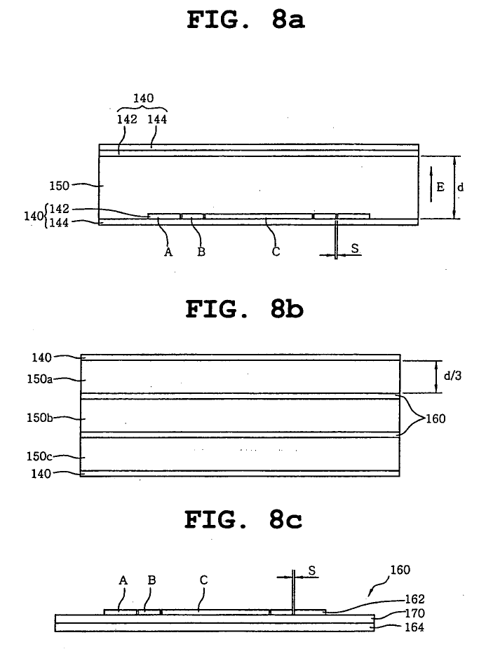

FIGS. 8a-8c depict structures of the optical element with a monolayer liquid crystal-photopolymer in accordance with an embodiment of the present invention and with a plurality of sub liquid crystal photopolymers in accordance with another embodiment of the present invention (8b), and shows a sub-transparent substrate electrode in an enlarged view (8c). In these drawings, a liquid crystal-photopolymer 150 is expressed as a single unit without division into the polymer matrix 42 (FIG. 4) and the droplets 44 (FIG. 4).

As seen in FIG. 8a, the optical element according to an embodiment of the present invention comprises a pair of transparent electrode substrates 140, with a liquid crystal-photopolymer 150, e.g., PDLC, interposed therebetween. The transparent electrode substrate 140 is formed by coating indium tin oxide (ITO) 142 on a transparent, electrically conductive film 144. On one of the pair of transparent electrode substrates 140 (lower substrate in FIG. 8a), the ITO film 142 is formed in concentrically circular patterns to which an electric field is selectively applied.

The patterns A, B and C are positioned at a predetermined space S which is preferably too minute to recognize with the naked eye in the image made by the lens. Therefore, the space is set to have no effects on images made by use of the optical element according to the present invention.

The power (V) supplied to realign the droplets within the PDLC can be defined by the multiplication of the applied electric field (E) and the thickness of the PDLC, as follows:
V=Ed Equation 1

Because the electric field is required to be constant, the power (i.e., voltage) supplied for the realignment of the droplets is proportional to the thickness of the PDLC.
V∝d Equation 2

Therefore, the power supplied to the optical element can be decreased by reducing the thickness of the liquid crystal-photopolymer in the optical element. As such, a requirement for low power for operating optical elements is necessary for the fabrication of smaller image pickup modules.

In FIG. 8b, a liquid crystal-photopolymer 150 interposed between a pair of transparent electrode substrates 140 is equally divided into three sub liquid crystal-photopolymer layers 150a, 150b and 150c by two sub transparent electrode substrates 160, with all transparent electrode substrates positioned at equal distances. As the liquid crystal-photopolymer layer 150 is divided into the sub liquid crystal-photopolymer layers 150a, 150b and 150c, the thickness of each of the sub liquid crystal-photopolymers is reduced to about one third of that of the intact liquid crystal-photopolymer layer. Accordingly, the power supplied to each sub liquid crystal-photopolymer layers can be reduced by the same proportion.

According to FIG. 8c which shows a sub transparent electrode substrate 160 in detail, it is fabricated by forming an ITO film 162 in predetermined patterns A, B and C on a transparent insulator 170 deposited on a flat ITO film 164. On each side of each of the sub liquid crystal-photopolymer layers 150a, 150b and 150c is formed a transparent electrode substrate. When viewed totally, the optical element according to the present invention is structured to have a plurality of unit elements, each consisting of a transparent electrode substrate-liquid crystal photopolymer-transparent electrode substrate, with a transparent insulator interposed between the unit elements.

As a result, the power (V) necessary for the optical element of FIG. 8b is reduced to about one third relative to that of FIG. 8a. In contrast to the intact liquid crystal-photopolymer 150 of FIG. 8a, the unit element across which an electric field is applied is the sub liquid crystal-photopolymer layer 150a, 150b or 150c, which is trisected from the intact one. As the thickness of the unit element is decreased to one third, the voltage required for the operation of the optical element is also reduced by the same proportion when account is taken of the fact that the applied electric field is constant.

A reduction in the quantity of power required to change the refractive index of the liquid crystal-photopolymer makes a module comprising the liquid crystal-photopolymer slimmer or smaller, giving a contribution to the minimization of electronic appliances with such modules (e.g., digital still cameras).

For the power supplied to the optical element of the present invention, an alternative current is used so as to prevent the electric field from being shielded on the surface of the droplets within the PDLC. In detail, where an electric field is applied to the PDLC by the supply of a direct current, the realignment of charges occurs at the interface between the droplets and the polymer matrix in the PDLC so as to shield the application of the electric field into the droplets.

As described above, the present invention is directed to an optical element comprising a pair of transparent electrode substrates with a liquid crystal-photopolymer, such as PDLC, interposed therebetween, which can be electrically operated to function as an aperture and/or a shutter without additional mechanical operating means, and to an image pickup module comprising the optical element. In addition, based on the advantage of requiring only a small quantity of power for its operation by dividing the liquid crystal-photopolymer layer into many sub liquid crystal-photopolymer layers, the image pickup module according to the present invention can be employed in miniaturized electronic appliances which operate at low power.

Accordingly, the electrically operating optical element capable of functioning as an aperture and a shutter in accordance with the present invention can reduce the size of the image pickup module in addition to protecting the image pickup module from mechanical noises and impacts which arise from the use of mechanical driving means.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image pickup module, comprising;
a lens;
a sensor converting the light passing through the lens into electrical signals; and
an optical element controlling the quantity of light and exposure time, wherein the optical element comprises:
a liquid crystal-photopolymer layer capable of passing light upon the application of an electric field thereto; and
a pair of transparent electrode substrates wherein one substrate is positioned on an upper and the other substrate on a lower surface of the liquid crystal-photopolymer layer, the transparent electrode substrate further comprising an electrode pattern for applying an electric field across the liquid crystal-photopolymer layer, wherein the electrode pattern on one of the pair of transparent electrode substrates are concentric circles wherein each concentrate circle has an area about half that of the next outer circle.

2. The image pickup module as set forth in claim 1, wherein the liquid crystal-photopolymer layer is a polymer-dispersed liquid crystal.

3. The image pickup module as set forth in claim 1, wherein the liquid crystal-photopolymer layer is equally divided into a plurality of sub liquid crystal photopolymer layers by a plurality of sub transparent electrode substrates, formed parallel to the pair of transparent electrode substrates, at equal distances within the liquid crystal-photopolymer layer.

4. The image pickup module as set forth in claim 3, wherein each of the sub transparent electrode substrates comprises a pair of an upper and a lower transparent electrode substrates and a transparent insulator interposed therebetween.

5. The image pickup module as set forth in claim 1, wherein the electric field is provided by an alternating current power source.

6. The image pickup module as set forth in claim 1, wherein the electric field is selectively applied to at least one of the concentric circles of the optical element to function as an aperture.

7. The image pickup module as set forth in claim 1, wherein the electric field is turned off to allow the liquid crystal-photopolymer of the optical element to shield the transmission of light and function as a shutter.

8. The image pickup module as set forth in claim 6, wherein the electric field is turned off to allow the liquid crystal-photopolymer of the optical element to shield the transmission of light and function as a shutter.

9. The image pickup module as set forth in claim 3, wherein each of the sub transparent electrode substrates comprises a pair of an upper and a lower indium tin oxide (ITO) films and a transparent insulator interposed therebetween.
